(19) United States
(12) Patent Application Publication
(10) Pub. No.: US 2016/0155131 A1
(43) Pub. Date: Jun. 2, 2016

(54) SYSTEM AND METHOD FOR FULLY TESTING A SYSTEM BEFORE AND AFTER AN UPGRADE TO VERIFY FULL USE CASE COMPLIANCE

(71) Applicant: EIS Group Software Ireland Limited, San Francisco, CA (US)

(72) Inventors: Alec Miloslavsky, San Francisco, CA (US); Girts Baltaisbrencis, San Francisco, CA (US); Andris Silis, Riga (LV)

(21) Appl. No.: 14/955,024

(22) Filed: Nov. 30, 2015

Related U.S. Application Data
(60) Provisional application No. 62/085,485, filed on Nov. 28, 2014.

(51) Int. Cl. G06Q 30/00; G06F 11/36; G06F 9/445

(52) U.S. Cl. CPC G06Q 30/018; G06F 8/65; G06F 11/3692; G06F 11/3684

(57) ABSTRACT

A system to fully test a computer system before and after an upgrade to verify full use case compliance is disclosed. The system includes a computer server specific for a company's business operations; a data store holding the company's business data; a use case data store module; a use case test reference result data store module; a use case test execution module; and an output module.

### CROSS-REFERENCE TO RELATED APPLICATIONS

This application claims priority to United States provisional patent application Ser. No. 62/085,485 titled “SYSTEM AND METHOD FOR FULLY TESTING A SYSTEM BEFORE AND AFTER AN UPGRADE TO VERIFY FULL USE CASE COMPLIANCE” filed on Nov. 26, 2014, the specification of which is incorporated herein in its entirety by reference.

### BACKGROUND OF THE INVENTION

1. Field of the Invention

The present invention is in the field of computer systems testing, more specifically fully testing a computer system before and after an upgrade to verify full use case compliance.

2. Discussion of the State of the Art

A major concern during a system upgrade is that on one hand, there is an urgency to do the updates quickly, to secure the system and to return the system to service; while on the other hand there is apprehension that some part or parts of the system, large or small, may stop working, either fully or partially, potentially insidiously, due to incompatibilities among software introduced at some step of the upgrade. What is needed is a system and method for removing the uncertainty involved in managing computer system changes including but not limited to application updates and upgrades, operating system upgrades and database updates, revisions such that post-upgrade failure of a business's critical processes can be systematically determined and resolved prior to return of a computer system to live service.

### SUMMARY OF THE INVENTION

The inventor has developed a system to fully test a computer system before and after an upgrade to verify compliance of the post-upgrade system with reference results obtained for all identified business processes obtained prior to the system changes. This status is designated full use case compliance.

According to a preferred embodiment of the invention, a system to fully test a computer system before and after an upgrade to verify full use case compliance comprising a computer server specific for a company's business operations stored in a memory of and operating on a processor of a computing device, a data store holding the company's business data stored in a memory of and operating on a processor of a computing device, a use case data store module stored in a memory of and operating on a processor of a computing device, a use case test reference result data store module stored in a memory of and operating on a processor of one of more computing devices, a use case test execution module stored in a memory of and operating on a processor of a computing device and an output module stored in a memory of and operating on a processor of a computing device is disclosed. The computer server specific for a company's business operations: is partially comprised of a plurality of applications specific for the business operations of a company at least some of which will need to be upgraded one or more times for reasons that include but are not limited to security flaws, bug corrections or feature additions; is partially comprised of a plurality of support applications that are not specific for the company or its business operations but provide services that effect the function of the company specific applications and at least some of which will need to be upgraded one or more times for reasons that include, but are not limited to, security flaw, bug correction or feature addition and is partially comprised of an operating system that provides programmed services that in tow may effect all other processes on the server and at least some of which will need to be upgraded one or more times for reasons that include, but are not limited to, security flaw, bug correction or feature addition. The data store holding the company's business data may undergo database or table upgrade that may effect the company's ability to retrieve the data in a timely fashion. The use case data store module: holds one or more use case tests which analyze a plurality of software functions crucial to the company's business operations and serves as a repository of defined seed data used to produce reference result data and post system upgrade result data. The use case test reference result data store module: holds results from pre-upgrade control execution of each use case test using each test's assigned seed data and supplies pre-upgrade use case test results for comparison to results obtained from post-upgrade execution of the same use case test. The use case test execution module: retrieves one or more use case tests from the use case test data store module; may execute pre-designated use case tests with specific seed data prior to an upgrade to the computer server specific for a company's business operations or the data store holding the company's business data to create reference results to be stored in the use case test suite reference result data store module; executes pre-designated use case tests with specific seed data after and upgrade to the computer server specific for a company's business operations or the data store that holds the company's business data; retrieves use case test reference results from the use case test reference result data store module for use case tests executed; compares the results of use case tests run after an upgrade to the computer server specific for a company's business operations or the data store holding the company's business data with the pre-upgrade reference results of the same use case tests and sends use case compliance confirmation messages or use case test failure information to the output module. Finally, the output module transmits all results of use case test execution by a method predetermined by the system administrators.

According to another preferred embodiment of the invention, a method to fully test a computer system before and after an upgrade to verify full use case compliance has been developed, the method steps comprising: To develop use case tests and seed data to analyze business critical processes. To store all use case tests and seed data in a database for future deployment. To execute all use case tests using the matching seed data prior to any intended business critical computer system upgrade to generate pre-upgrade reference result data. To store the reference result data for each use case test for comparison with post-system-upgrade results from the same use case tests and seed data. To perform the intended upgrade of the business critical computer system. To execute desired use case tests using matching designated seed data for each use case test. To collect results of the post-upgrade tests and compare them to the reference pre-upgrade result data for the same tests. To issue a compliance certification if all use case tests are passed. To issue a warning with all predetermined diagnostic data if one or more use case tests produce post upgrade results that differ from the reference result data or if one or more use case tests fail to complete. To perform remedial action as desired prior to returning the system to live service.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary and are not intended to limit the scope of the present invention.

FIG. 1 is a block diagram illustrating an exemplary hardware architecture of a computing device used in various embodiments of the invention.

FIG. 2 is a block diagram illustrating an exemplary logical architecture for a client device, according to various embodiments of the invention.

FIG. 3 is a block diagram illustrating an exemplary architectural arrangement of clients, servers, and external services, according to various embodiments of the invention.

FIG. 4 is a block diagram illustrating an exemplary overview of a computer system as may be used in any of the various locations throughout the system

FIG. 5 is a diagram of an exemplary architecture of a system to fully test a computer system before and after an upgrade to verify full use case compliance according to an embodiment of the invention.

FIG. 6 is a method diagram showing exemplary steps employed to fully test a computer system before and after an upgrade to verify full use case compliance according to an embodiment of the invention.

### DETAILED DESCRIPTION

The inventor has conceived, and reduced to practice, various systems and methods to fully test a computer system before and after an upgrade to verify full use case compliance

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring sequentially (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

A “database” or “data store” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, key-value databases, column-oriented databases, in-memory databases, and the like. While various embodiments may preferentially employ one or another of the various data storage subsystems available in the art (or available in the future), the invention should not be construed to be so limited, as any data storage architecture may be used according to the embodiments. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be disclosed herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system possibly networked with others in a data processing center, a mobile computing device (e.g., tablet computing device, mobile phone, smartphone, laptop, and the like), a consumer electronic device, a music player, or any other suitable electronic device, router, switch, or the like, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or the like).

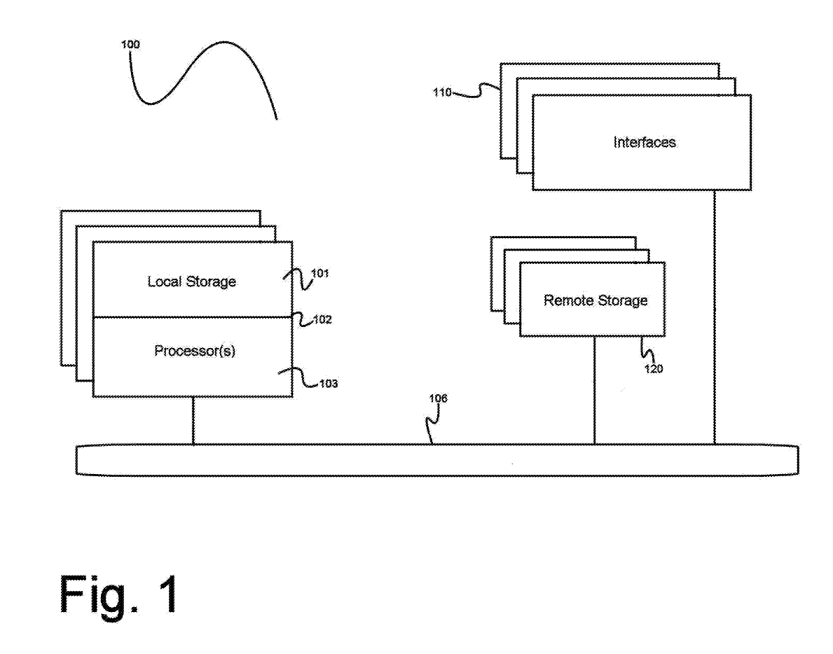

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more buses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, Firewire, PCI, parallel, radio frequency (RF), Bluetooth, near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include ports appropriate for communication with appropriate media. In some cases, they may also include an independent processor and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both object code, such as may be produced by a compiler, machine code, such as may be produced by an assembler or a linker, byte code, such as may be generated by for example a Java compiler and may be executed using a Java virtual machine or equivalent, or files containing higher level code that may be executed by the computer using an interpreter (for example, scripts written in Python, Perl, Ruby, Groovy, or any other scripting language).

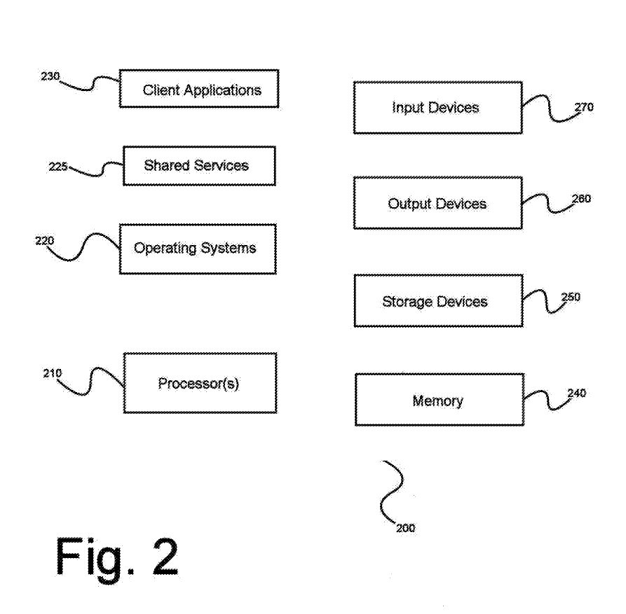

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's Windows operating system, Apple's Mac OS/X or iOS operating systems, some variety of the Linux operating system, Google's Android operating system, or the like. In many cases, one or more shared services 225 may be operable in system 200, and may be useful for providing common services to client applications 230. Services 225 may for example be Windows services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form. Examples of storage devices 250 include flash memory, magnetic hard drive, CD-ROM, and/or the like.

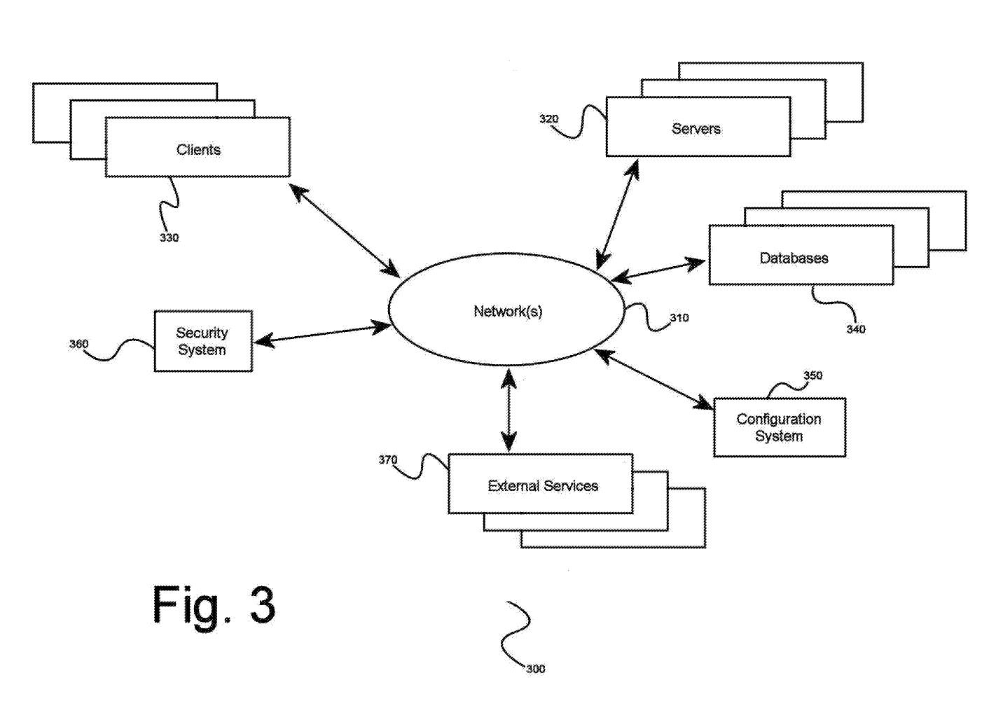

In some embodiments, systems of the present invention may be implemented on a distributed computing network, such as one having any number of clients and/or servers. Referring now to FIG. 3, there is shown a block diagram depicting an exemplary architecture for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments of the Internet, a wide area network, a mobile telephony network, a wireless network (such as WiFi, Wimax, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop, MapReduce, BigTable, MongoDB, Redis and so forth). In some embodiments variant database architectures such as column-oriented databases, in-memory databases, clustered databases, distributed databases, key-value stores, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration 350 system or approach is specifically required by the description of any specific embodiment.

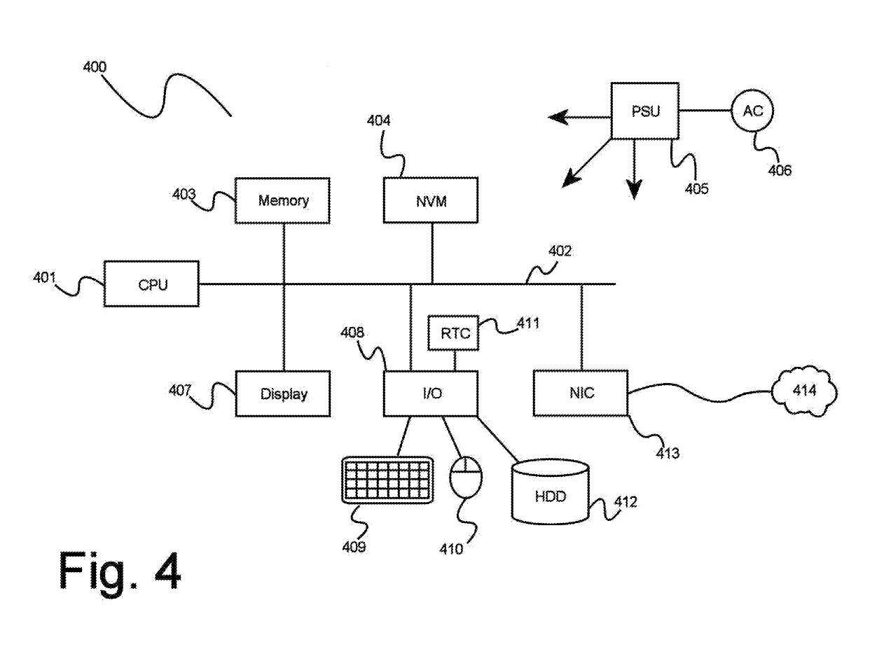

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

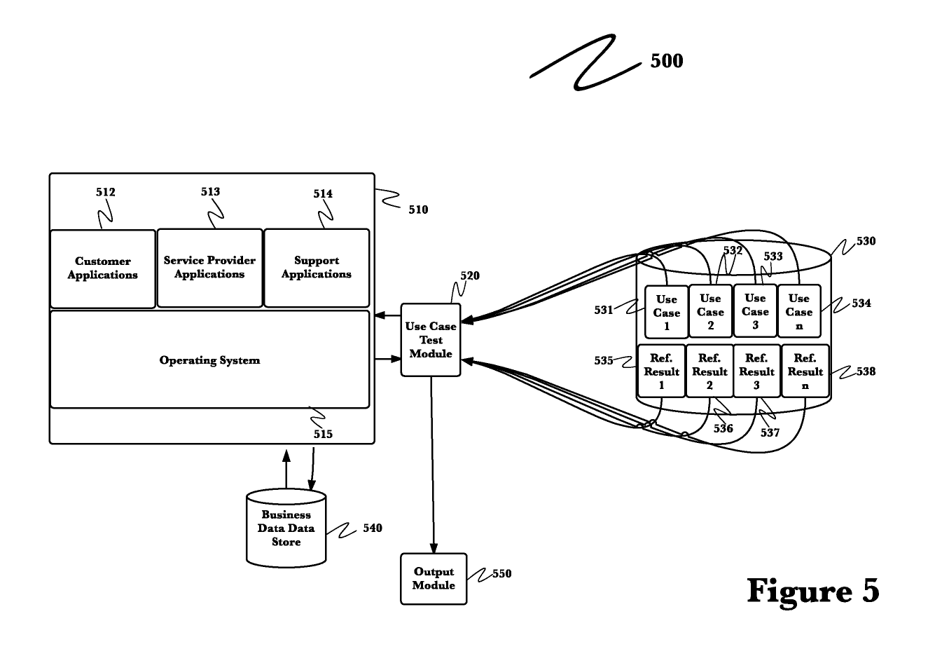

FIG. 5 is a diagram of an exemplary architecture of a system to fully test a computer system before and after an upgrade to verify full use case compliance 500 according to an embodiment of the invention. According to the embodiment, an exemplary computer system 510 carrying out processes critical to a company's business processes at some point in time requires a change to be made, such as an update or upgrade to applications directly used by the company in its business practices 512, an update or upgrade to applications that are not directly used by the company for its business practices but which support or can effect the function of company specific applications 514, or requires an upgrade to the system's underlying operating system 515, which has great potential to effect function of one or more of the company's business applications 512. In another example, the company may need to revise one or more databases or database tables that store critical business practice data in one of their data stores 540. It is also possible that the management software of the data store is the upgrade target 540. In yet another example, the company's server may be administered or both hosted and administered by a third party and that third party may have one or more applications on the system for their use that require upgrade 513. In all the preceding examples, there is the potential that the changes made to the system will result in a complete loss of function in one or more of the company's business process applications 512. Equally serious, and often worse, is a case where one or more business process applications apparently continue to function but it is determined at some point that the results of data manipulation by those applications are incorrect and so, the company's data from after the upgrade until discovery of the problem are corrupt or lost. The invention provides a framework 530 with which to develop tests 531, 532, 533, 534 to analyze all aspects of business critical application processes using sets of test specific seed data 531, 532, 533, 534. Together, these tests and their seed data are called use cases. The use case tests may comprise only a command to initiate a specific critical company application with the matching seed data or may comprise significant programming instructions to initiate the critical company application in a highly specific configuration or at a specific defined point within its operation. Each use case may also contain one or a plurality of sets of seed data, as needed, to fully test the target business critical application. Use cases 531, 532, 533, 534 that analyze different aspects of the same or similar business processes may be grouped together to form suites that can be initiated together; however, this is only a convenience, as the invention does not rely on grouping for function, and use cases might be grouped in any fashion logical to those executing them. Use cases are executed at least once during a steady state period prior to a planned business system update or upgrade so as to generate one or more sets of reference results for each use case 535, 536, 537, 538. While the invention relies on the generation of reference result data for each use case to be executed for its function, there is no requirement on when the use cases to generate that reference data are run, or how many times the reference data is generated. Conceivably, the use cases might be executed only once, as early aa an initial system go-live, to generate reference result data, or they may be executed as frequently as once an hour until the upgrade is carried out; the function of the invention is not affected by such choices, since the presence of one valid set of reference results 535, 536, 537, 538 for each intended use case is sufficient. Upon completion of an upgrade of the system, desired use cases are run by use case test module 520, which retrieves each use case from data store 530, executes each use case with each seed data set assigned, compares the result of each current execution of each use case with the reference result set obtained using the same seed data set, and then passes either compliance certification messages or failure messages and failure specifications to output module 550. Output module 550 formats the results of the use case executions per predetermined parameters and transmits them following the instructions of the designers of the upgrade. This method will often be by printout, although this is not required and other output means known in the art may be used without limitation. The output could be formatted and, as one example, sent to a supervisory server for automated response, such as perhaps remediation as needed. The invention makes no assumption or stipulations in the form of output. Furthermore, under the invention the use cases may be initiated at the completion of an upgrade either manually—from a console, terminal, or other device requiring human interaction—or through monitor software on a server that has been preprogrammed to execute certain use cases when specific conditions such as company business process application upgrades 512, server support application upgrades 514, service provider application upgrades 513, or server operating system upgrades 515 complete. The method of use case initiation should not limit the scope of the invention. The execution of use cases under the invention is also not limited to the type or location of the server 510, which may be a single physical entity or several distinct entities separated possibly separated by great distances. The use case store may be located on the same rack or it may be many miles away. In some embodiments, server 510 may be owned by the company, while the use cases, seed data, and reference result data may be housed and owned by a service provider for whom the company is a customer. The converse would also be within the scope of the invention. Under the invention, server 510 may be a physical system or one of many virtual servers either in the data center of the customer or at a service provider for whom the company is a customer. The invention also makes no distinction between whether the use cases are run on the company's live server or executed on a test server that mirrors the company's live server and is upgraded prior to the company's live server to minimize the impact of upgrades on the company's live business practices.

### Description of Method Embodiments

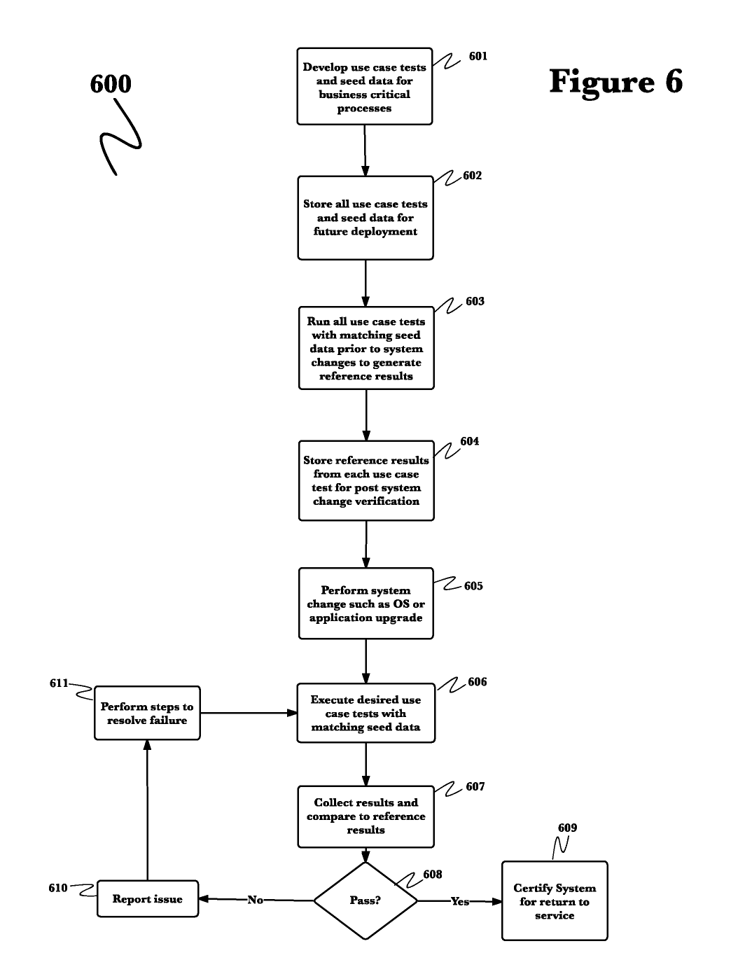

FIG. 6 is a method diagram showing exemplary steps employed to fully test a computer system before and after an upgrade to verify full use case compliance 600 according to an embodiment of the invention. The method includes the step of developing one or more tests 601 which analyze every aspect of the function of a company's business process computer software applications 512 deemed by the company to be critical to its business practices. These tests are devised to analyze the function of all business applications after a server 510 has been upgraded Once these tests are designed and the programming for each—which may be as simple as a single command to initiate the target business application to as complex as many lines of code to configure the business application in a specific way or execute it from a specific point in its operation—one or more sets of seed data, each designed to give rise to an identifiable reference result upon interaction with the business application, may be devised. The combination of the test programming and all of its associated seed data form a use case 601. Both the test programming and any associated seed data are stored in a data store 530 for future deployment in step 602. At any time prior to an intended update, revision or upgrade of the operating system of or applications hosted on the company's business critical server, all of the use case tests are run in step 603 with all of each use case test's associated seed data to generate pre-upgrade reference results, which will be used to verify proper function of each tested business critical function after the upgrade is completed (in step 607). These reference results are held in a data store 530 until needed in step 604. Once the reference result data has been generated, the intended update, revision or upgrade can be performed at any time required in step 605. Upon completion of the intended upgrade, use cases that have been designated to be executed based upon the specifics of the upgrade are run in step 606. The invention is not restricted to a particular for of use case initiation and any method, such as manual initiation of individual use cases, manual initiation of groups of related use cases or automated initiation of individual or grouped use cases are all considered equivalent. The results of the use cases executed after completion of the planned upgrade are compared to the reference result data for the same use cases prior to the upgrade in step 607 and, based upon whether the reference results and post-upgrade results agree (step 608), the system is either certified to be returned to service in step 609 or reports of the failure containing any pre-determined analysis data are issued in step 610 and steps may be taken to resolve any issues at the discretion of the programmers. Associated use cases may be re-executed and the results obtained compared to reference result data to confirm full use case compliance (steps 606 and 607) after any remedial steps are completed.

The skilled person will be aware of a range of possible modifications of the various embodiments described above. Accordingly, the present invention is defined by the claims and their equivalents.

What is claimed is:

1. A system to fully test a computer system before and after an upgrade to verify full use case compliance comprising:
a computer server specific for a company's business operations stored in a memory of and operating on a processor of a computing device;
a data store holding the company's business data stored in a memory of and operating on a processor of a computing device;
a use case data store module stored in a memory of and operating on a processor of a computing device;
a use case test reference result data store module stored in a memory of and operating on a processor of one of more computing devices;
a use case test execution module stored in a memory of and operating on a processor of a computing device; and
an output module stored in a memory of and operating on a processor of a computing device;
wherein the computer server specific for a company's business operations:
(a) is partially comprised of a plurality of applications specific for the business operations of a company at least some of which will need to be upgraded one or more times for reasons that include but are not limited to security flaws, bug corrections or feature addition;
(b) is partially comprised of a plurality of support applications that are not specific for the company or its business operations but provide services that effect the function of the company specific applications and at least some of which will need to be upgraded one or more times for reasons that include, but are not limited to, security flaws, bug corrections or feature addition;
(c) is partially comprised of an operating system that provides programmed services that in tow may effect all other processes on the server and at least some of which will need to be upgraded one or more times for reasons that include, but are not limited to, security flaws, bug corrections or feature addition; and
wherein the data store holding the company's business data:
(d) may undergo database or table upgrade that may effect the company's ability to retrieve the data in a timely fashion; and
wherein the use case data store module:
(e) holds one or more use case tests which analyze a plurality of software functions crucial to the company's business operations;
(f) serves as a repository of defined seed data used to produce reference result data and post system upgrade result data; and
wherein the use case test reference result data store module:
(g) holds results from pre-upgrade control execution of each use case test using each test's assigned seed data;
(h) supplies pre-upgrade use case test results for comparison to results obtained from post-upgrade execution of the same use case test; and
wherein the use case test execution module:
(i) retrieves one or more use case tests from the use case test data store module;
(j) may execute pre-designated use case tests with specific seed data prior to an upgrade to the computer server specific for a company's business operations or the data store holding the company's business data to create reference results to be stored in the use case test suite reference result data store module;
(k) executes pre-designated use case tests with specific seed data after and upgrade to the computer server specific for a company's business operations or the data store that holds the company's business data;
(l) retrieves use case test reference results from the use case test reference result data store module for use case tests executed;
(m) compares the results of use case tests run after an upgrade to the computer server specific for a company's business operations or the data store holding the company's business data with the pre-upgrade reference results of the same use case tests;
(n) sends use case compliance confirmation messages or use case test failure information to the output module; and
wherein the output module:
(o) transmits all results of use case test execution by a method predetermined by the system administrators.

2. The system of claim 1, wherein the computer server specific for a company's business operations and the data store holding the company's business data are one or more physical servers or virtual servers in one or more racks in the datacenters of the company in whose business operations the server participates and the use case test suites are developed and administered by that company.

3. The system of claim 1, wherein the computer server specific for a company's business operations and the data store holding the company's business data are one or more physical servers or virtual servers in one or more racks in the datacenters of a third party which administers the servers and may provide the servers as well as software as a service to the company as a customer and the use case test suites may be supplied completely by the service provider, completely by the customer company or by a mixture of both sources.

4. The system of claim 1, wherein the upgrade and use case tests are first executed on a test server, either physical or virtual, that mirrors the company's live server so that use case test compliance failures can be uncovered and resolved without affecting the company's business processes.

5. The system of claim 1, wherein a plurality of use case tests are required to fulfill regulatory requirements such as, but not limited to, those found in financial, medical and energy industry related applications.

6. The system of claim 1, wherein two or more individual use case tests may be grouped into use case test suites based on the business process they analyze such that that plurality of tests can be executed as a single entity by a single action or command.

7. A method to fully test a computer system before and after an upgrade to verify full use case compliance, the method comprising the steps of:
(a) develop use case tests and seed data to analyze business critical processes;
(b) store all use case tests and seed data in a database for future deployment;
(c) execute all use case tests using the matching seed data prior to any intended business critical computer system upgrade to generate pre-upgrade reference result data;
(d) store the reference result data for each use case test for comparison with post-system-upgrade results from the same use case tests and seed data;
(e) perform the intended upgrade of the business critical computer system;
(f) execute desired use case tests using matching designated seed data for each use case test;
(g) collect results of the post-upgrade tests and compare them to the reference pre-upgrade result data for the same tests;
(h) issue a compliance certification if all use case tests are passed;
(i) issue a warning with all available predetermined diagnostic data if one or more use case tests produce post upgrade results that differ from the reference result data or if one or more use case tests fail to complete;
(j) perform any remedial action as desired.
